(19) United States
(12) Patent Application Publication
(10) Pub. No.: US 2026/0313421 A1
(43) Pub. Date: Oct. 8, 2026

(54) METHOD AND APPARATUS FOR ENHANCEMENTS ON REPORTING OF RECEPTION-TRANSMISSION TIME DIFFERENCE MEASUREMENT IN MOBILE COMMUNICATIONS

(71) Applicant: MEDIATEK INC., Hsinchu City (TW)

(72) Inventor: Chiao-Yao CHUANG, Hsinchu City (TW)

(21) Appl. No.: 19/481,627

(22) PCT Filed: May 15, 2024
(86) PCT No.: PCT/CN2024/093290

§ 371 Date: Nov. 5, 2025

Related U.S. Application Data
(60) Provisional application No. 63/502,141, filed on May 15, 2023.
(60) Provisional application No. 63/518,339, filed on Aug. 9, 2023.

(51) Int. Cl. H04W 24/10; H04W 64/00

(52) U.S. Cl. CPC H04W 24/10; H04W 64/006

(57) ABSTRACT

Various solutions for enhancements on reporting of reception-transmission (Rx-Tx) time difference measurement in mobile communications are described. A first apparatus may receive a first reference signal (RS) from a second apparatus. Then, the first apparatus may perform a first Rx-Tx time difference measurement based on the first RS. Also, the first apparatus may report the first Rx-Tx time difference measurement to a third apparatus. The first Rx-Tx time difference measurement may include an RS reception timestamp and an RS transmission timestamp.

### CROSS REFERENCE TO RELATED PATENT APPLICATION(S)

The present disclosure is part of a non-provisional application claiming the priority benefit of U.S. Patent Application No. 63/502,141, filed 15 May 2023, and U.S. Patent Application No. 63/518,339, filed 9 Aug. 2023. The contents of aforementioned applications are herein incorporated by reference in their entirety.

### TECHNICAL FIELD

The present disclosure is generally related to mobile communications and, more particularly, to enhancements on reporting of reception-transmission (Rx-Tx) time difference measurement in mobile communications.

### BACKGROUND

Unless otherwise indicated herein, approaches described in this section are not prior art to the claims listed below and are not admitted as prior art by inclusion in this section.

In a fourth generation (4G) Long-Term Evolution (LTE) system or a fifth generation (5G) New Radio (NR) system, sidelink (SL) communication (e.g., vehicle-to-vehicle (V2V) communication or vehicle-to-everything (V2X) communication) is supported which allows a direct link to be established between multiple user equipments (UEs). Specifically, in SL communication, UEs can exchange information/data directly with each other with or without participation of a cellular network. When a UE is within the coverage of one cellular network, the SL communication can be operated under the control of the cellular network (e.g., for radio resource allocation). Alternatively, when no cellular system is present or reachable, the SL communication can be operated independently based on pre-configured resources.

SL-positioning reference signal (SL-PRS) is a reference signal (RS) used in SL communication for the purpose of UE positioning. Under current SL framework, two UEs may each transmit an SL-PRS to one other, and each report an Rx-Tx time difference measurement based on the received SL-PRS. With these Rx-Tx time difference measurements, the round-trip time (RTT) or propagation delay between two UEs can be estimated and used to determine the relative position information of the UEs. In current 3^{rd} Generation Partnership Project (3GPP) standards, the definition of UE Rx-Tx time difference indicates that the transmit (Tx) timing used for the Rx-Tx time difference measurement is the intended Tx timing that is closest in time to the received (Rx) timing of RS. The “intended” Tx timing means that it is an up-to-date Tx timing to be prepared for any uplink (UL) transmission, and if there is an UL signal for transmission at this moment, then this Tx timing would be applied. That is to say, the Rx timing and the intended Tx timing may share the same timestamp, and in reporting of each Rx-Tx time difference measurement, only the timestamp for Rx measurement is attached. However, the UE's actual timing for an UL signal transmission may change (e.g., due to clock drift detected by measuring signals from network), causing the actual Tx timing different from the intended Tx timing during the measurement. Consequently, UE positioning with the reported Rx-Tx time difference measurement may not be accurate.

Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to reporting of Rx-Tx time difference measurement in mobile communications.

In one aspect, a method may involve a first apparatus receiving a first RS from a second apparatus. The method may also involve the first apparatus performing a first Rx-Tx time difference measurement based on the first RS. The method may further involve the first apparatus reporting the first Rx-Tx time difference measurement to a third apparatus, wherein the first Rx-Tx time difference measurement comprises an RS reception timestamp and an RS transmission timestamp.

In one aspect, a first apparatus may comprise a transceiver which, during operation, wirelessly communicates with a second apparatus or a third apparatus. The first apparatus may also comprise a processor communicatively coupled to the transceiver. The processor, during operation, may perform operations comprising receiving, via the transceiver, a first RS from the second apparatus. The processor may also perform operations comprising performing, via the transceiver, a first Rx-Tx time difference measurement based on the first RS. The processor may further perform operations comprising reporting, via the transceiver, the first Rx-Tx time difference measurement to the third apparatus, wherein the first Rx-Tx time difference measurement comprises an RS reception timestamp and an RS transmission timestamp.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of LTE/NR positioning framework under schemes in accordance with implementations of the present disclosure.

FIG. 2 is a diagram depicting an example scenario of SL positioning framework under schemes in accordance with implementations of the present disclosure.

FIG. 3 is a diagram depicting an example scenario of reporting SL Rx-Tx time difference measurements under schemes in accordance with implementations of the present disclosure.

FIG. 4 is a diagram depicting an example scenario of reporting SL Rx-Tx time difference measurements under schemes in accordance with implementations of the present disclosure.

FIG. 5 is a diagram depicting an example scenario of reporting SL Rx-Tx time difference measurements under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on reporting of Rx-Tx time difference measurement in mobile communications. According to the present disclosure, a number of possible solutions may be implemented separately or jointly. That is, although these possible solutions may be described below separately, two or more of these possible solutions may be implemented in one combination or another.

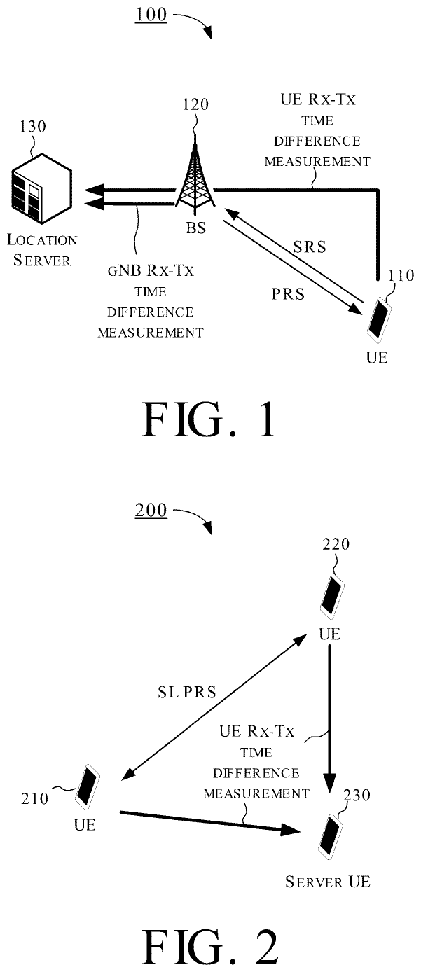

FIG. 1 illustrates an example scenario 100 of LTE/NR positioning framework under schemes in accordance with implementations of the present disclosure. Scenario 100 involves a UE 110 in wireless communication with a BS 120 (e.g., an evolved Node-B (eNB), a Next Generation Node-B (gNB), or a transmission/reception point (TRP)) and a location server 130, which may be a part of a wireless network (e.g., an LTE network, an NR network, an IoT network or a 6G network). For UE positioning, the BS 120 may transmit a PRS or a channel state information-reference signal (CSI-RS) to the UE 110, while the UE 110 may transmit a sounding reference signal (SRS) to the BS 120. Each of the UE 110 and the BS 120 may perform Rx-Tx time difference measurement based on the RS received from one another. Then, the UE 110 and the BS 120 may each report the Rx-Tx time difference measurement to the location server 130, such that the location server 130 may estimate the RTT or the propagation delay between the UE 110 and the BS 120 for determining the position information of the UE 110 relative to the BS 120. In one example, the location server 130 may be a location management function (LMF) in a 5G NR network. Although not shown, to improve the precision of UE position determination, the positioning framework may involve more than one BS and the UE 110 may report multiple Rx-Tx time difference measurements based on the PRSs/CSI-RSs received from different BSS.

FIG. 2 illustrates an example scenario 200 of SL positioning framework under schemes in accordance with implementations of the present disclosure. Scenario 200 involves two UEs 210 and 220 in SL communication with each other, without participation of a wireless network (e.g., an LTE network, an NR network, an IoT network or a 6G network). For UE positioning, the UEs 210 and 220 may each transmit an SL-PRS to one another for Rx-Tx time difference measurement. Then, each of the UEs 210 and 220 may report the Rx-Tx time difference measurement to the server UE 230, such that the server UE 230 may estimate the RTT or the propagation delay between the UEs 210 and 220 for determining the relative position information of the UEs 210 and 220. The server UE 230 may be co-located with the target (like UE-based positioning on Uu) or separate. Although not shown, to improve the precision of UE position determination, the positioning framework may involve additional UE(s) (may be called reference or anchor UE(s)) in SL-PRS transmission/reception and reporting of Rx-Tx time difference measurement.

It is noteworthy that the present disclosure proposes a number of schemes pertaining to enhancements on reporting of Rx-Tx time difference measurement in mobile communications. According to the schemes of the present disclosure, the UE reported Rx-Tx time difference measurement not only includes an RS reception timestamp that indicates the (configured) time when an RS (e.g., PRS/SL-PRS) is received, but also an RS transmission timestamp that indicates the (configured) time when an RS (e.g., SRS/SL-PRS) is transmitted, such that the location server 130 or the server UE 230 may be able to improve the precision of UE position determination. Each configured time may include at least one of the following: (i) a system frame number (SFN); (ii) a direct frame number (DFN); (iii) a slot number; and an RS resource identifier (ID) or an RS resource set ID or pool ID. More specifically, considering that the Tx timing of a UE may change, the configured time indicated in the RS transmission timestamp is prior to or after the configured time indicated in the RS reception timestamp, depending on whether the Tx timing change occurs before or after the reporting of Rx-Tx time difference measurement.

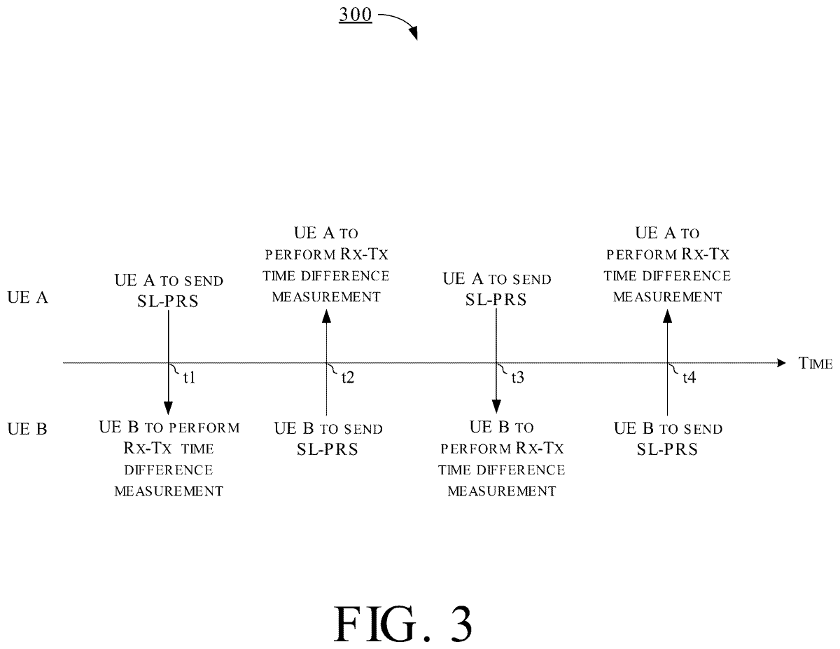

FIG. 3 illustrates an example scenario 300 of reporting SL Rx-Tx time difference measurements under schemes in accordance with implementations of the present disclosure. Scenario 300 involves two UEs (denoted as UE A and UE B) in SL communication for UE positioning. In scenario 300, it is assumed that both UE A and UE B are stationary at least in the shown time span, and that there is no sampling clock offset. As such, both UEs don't adjust their timing. Hence, the Rx-Tx time difference measurements at t1 and t2 may be combined for UE position determination in a third apparatus (e.g., the location server 130 or the server UE 230). Likewise, the Rx-Tx time difference measurements at t2 and t3 may be combined, and the Rx-Tx time difference measurements at t3 and t4 may be combined as well. It is noteworthy that the Rx-Tx time difference measurements adopt the intended Tx timing and the intended Tx timing is the same as the actual Tx timing since the UEs don't adjust their timing.

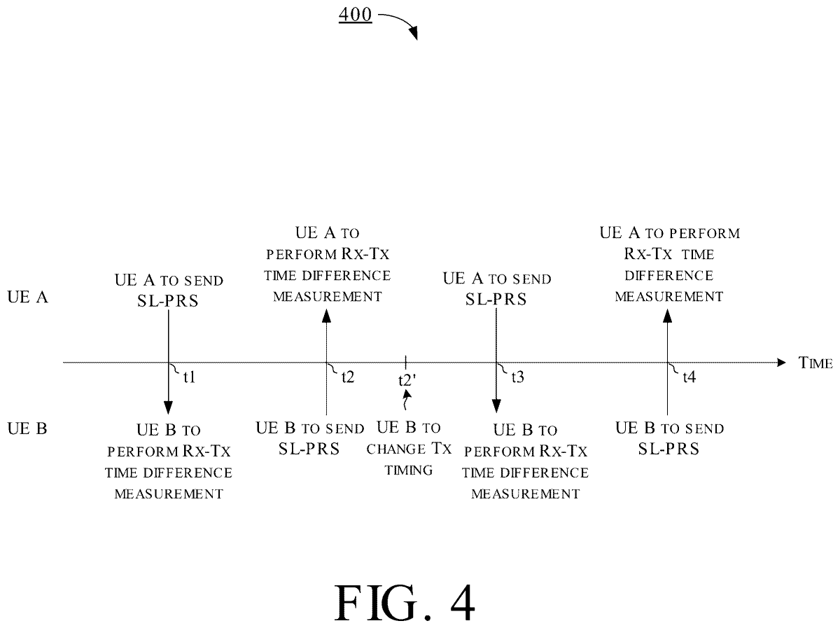

FIG. 4 illustrates an example scenario 400 of reporting SL Rx-Tx time difference measurements under schemes in accordance with implementations of the present disclosure. Scenario 400 involves two UEs (denoted as UE A and UE B) in SL communication for UE positioning, during which the Tx timing of one UE (e.g., UE B) is changed before the Rx-Tx time difference measurement at t3. In some implementations, UE B may report the Tx timing change with a corresponding timestamp (e.g., indicating time t2′), such that the third apparatus (e.g., the location server 130 or the server UE 230) may avoid combining the Rx-Tx time difference measurement by UE A at t2 and the Rx-Tx time difference measurement by UE B at t3 for UE position determination. In some implementations, UE B may report two Rx-Tx time difference measurements at t3, including one Rx-Tx time difference measurement using the Tx timing applied at t2, and another Rx-Tx time difference measurement using the Tx timing applied at t3 (same as the Tx timing changed at t2′). That is, these two Rx-Tx time difference measurements use the same Rx timing measured at t3. To further clarify, these two Rx-Tx time difference measurements reported by UE B with (Rx, Tx) timing at (t3, t2) and (t3, t3) are based on the same Rx timing measured at t3, and the difference between these two Rx-Tx time difference measurements is the amount of the Tx timing change. In particular, the Rx-Tx time difference measurement reported by UE B with (Rx, Tx) timing at (t3, t3) may be the same as the legacy definition of an Rx-Tx time difference measurement in which the Rx timing and the intended Tx timing may share the same timestamp. In some implementations, UE B may report the Rx-Tx time difference measurement with (Rx, Tx) timing at (t3, t3) and report the amount of Tx timing change with (Rx, Tx) timing at (t3, t2) relative to (t3, t3) timing.

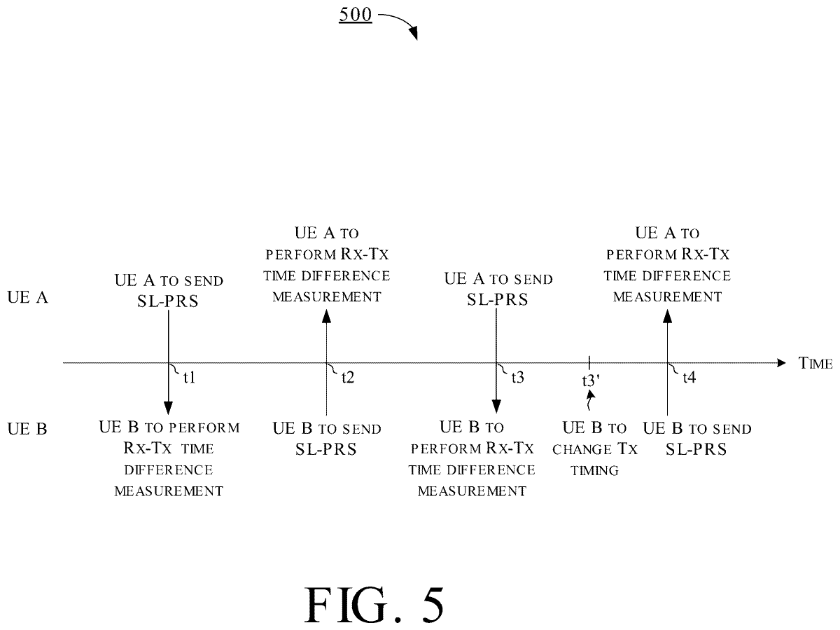

FIG. 5 illustrates an example scenario 500 of reporting SL Rx-Tx time difference measurements under schemes in accordance with implementations of the present disclosure. Scenario 500 involves two UEs (denoted as UE A and UE B) in SL communication for UE positioning, during which the Tx timing of one UE (e.g., UE B) is changed after the Rx-Tx time difference measurement at t3. In some implementations, UE B may report the Tx timing change with a corresponding timestamp (e.g., indicating time t3′), such that the third apparatus (e.g., the location server 130 or the server UE 230) may avoid combining the Rx-Tx time difference measurement by UE B at t3 and the Rx-Tx time difference measurement by UE A at t4 for UE position determination. In some implementations, UE B may report two Rx-Tx time difference measurements at t3, including one Rx-Tx time difference measurement using the Tx timing applied at t3 (same as actual Tx timing at t2), and another Rx-Tx time difference measurement using the Tx timing applied at t4. That is, these two Rx-Tx time difference measurements use the same Rx timing measured at t3. To further clarify, these two Rx-Tx time difference measurements reported by UE B with (Rx, Tx) timing at (t3, t4) and (t3, t3) are based on the same Rx timing measured at t3, and the difference between these two Rx-Tx time difference measurements is the amount of the Tx timing change. In particular, the Rx-Tx time difference measurement reported by UE B with (Rx, Tx) timing at (t3, t3) may be the same as the legacy definition of an Rx-Tx time difference measurement in which the Rx timing and the intended Tx timing may share the same timestamp. In some implementations, UE B may report the Rx-Tx time difference measurement with (Rx, Tx) timing at (t3, t3) and report the amount of Tx timing change with (Rx, Tx) timing at (t3, t4) relative to (t3, t3) timing.

In some implementations, the amount of the Tx timing change may indicate a time difference between a first Tx timing of UE B of the subframe where an SL-PRS is transmitted from UE B to UE A, and a second Tx timing of UE B of a subframe that is closest in time to the subframe where an SL-PRS is received from UE A.

It is noteworthy that, although FIGS. 3-5 illustrate the scenarios of reporting Rx-Tx time difference measurements for SL by the PC5 interface between two UEs, the proposed schemes of the present disclosure may also be applied to scenarios of reporting Rx-Tx time difference measurements for DL/UL by the Uu interface between a UE and a gNB/TRP.

### Illustrative Implementations

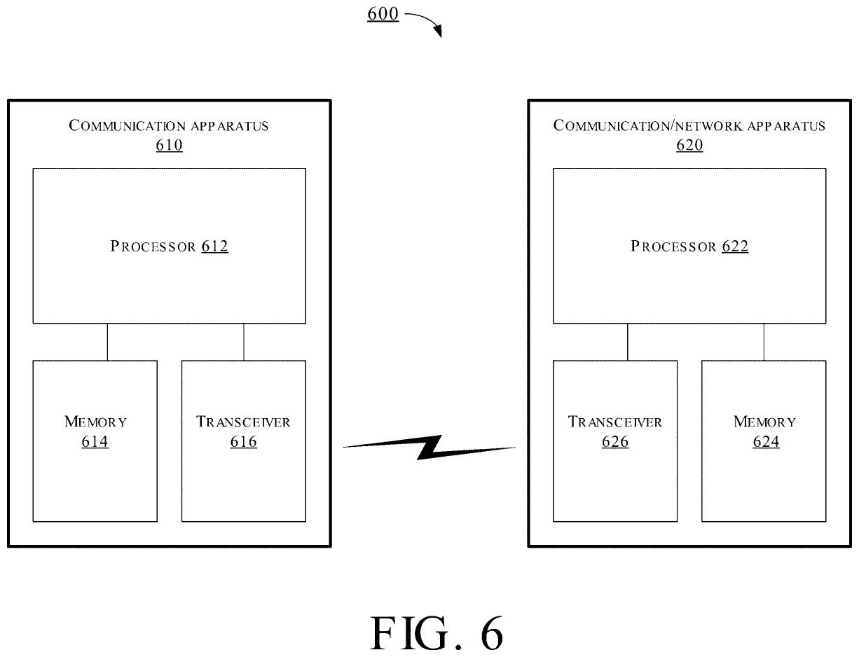

FIG. 6 illustrates an example communication system 600 having two example apparatuses 610 and 620 in accordance with an implementation of the present disclosure. Each of apparatus 610 and apparatus 620 may perform various functions to implement schemes, techniques, processes and methods described herein pertaining to enhancements on reporting of Rx-Tx time difference measurement in mobile communications, including scenarios/schemes described above as well as process 700 described below.

Apparatus 610 may be a communication apparatus that is a part of an electronic apparatus such as a portable or mobile apparatus, a wearable apparatus, a wireless communication apparatus or a computing apparatus. For instance, apparatus 610 may be implemented in a smartphone, a smartwatch, a personal digital assistant, a digital camera, or a computing equipment such as a tablet computer, a laptop computer or a notebook computer. Apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, apparatus 610 may be implemented in a smart thermostat, a smart fridge, a smart door lock, a wireless speaker or a home control center. Alternatively, apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 610 may include at least some of those components shown in FIG. 6 such as a processor 612, for example. Apparatus 610 may further include one or more other components not pertinent to the proposed scheme of the present disclosure (e.g., internal power supply, display device and/or user interface device), and, thus, such component(s) of apparatus 610 are neither shown in FIG. 6 nor described below in the interest of simplicity and brevity.

Apparatus 620 may be a communication apparatus or a network apparatus that is a part of an electronic apparatus, which may be a network node such as a BS, a small cell, a router or a gateway. For instance, apparatus 620 may be implemented in an eNB in a 4G LTE network, or a gNB/TRP in a 5G, B 5G, 6G, IoT, NB-IoT or IIoT network. Alternatively, apparatus 620 may be implemented in the form of one or more IC chips such as, for example and without limitation, one or more single-core processors, one or more multi-core processors, or one or more RISC or CISC processors. Apparatus 620 may include at least some of those components shown in FIG. 6 such as a processor 622, for example. Apparatus 620 may further include one or more other components not pertinent to the proposed scheme of the present disclosure (e.g., internal power supply, display device and/or user interface device), and, thus, such component(s) of apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including enhancements on reporting of Rx-Tx time difference measurement in a UE (e.g., as represented by apparatus 610) in accordance with various implementations of the present disclosure.

In some implementations, apparatus 610 may also include a transceiver 616 coupled to processor 612 and capable of wirelessly transmitting and receiving control and data signals. In some implementations, transceiver 616 may be capable of wirelessly communicating with different types of UEs and/or BSs of different RATs. In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, apparatus 620 may also include a transceiver 626 coupled to processor 622 and capable of wirelessly transmitting and receiving control and data signals. In some implementations, transceiver 626 may be capable of wirelessly communicating with different types of UEs and/or BSs of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications. Accordingly, apparatus 610 and apparatus 620 may wirelessly communicate with each other via transceiver 616 and transceiver 626, respectively.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of apparatus 610 and apparatus 620 may be a communication entity capable of communicating with each other using various proposed schemes in accordance with the present disclosure. For illustrative purposes and without limitation, a description of operations, functionalities, and capabilities of apparatus 610, implemented in or as a UE (e.g., the UE 110 or the UE 210), and apparatus 620, implemented in or as a BS (e.g., the BS 120) or a UE (e.g., the UE 220), is provided below.

According to certain proposed schemes of the present disclosure, processor 612 of apparatus 610 may receive, via transceiver 616, a first RS from apparatus 620. Then, processor 612 may perform, via transceiver 616, a first Rx-Tx time difference measurement based on the first RS. Also, processor 612 may report, via transceiver 616, the first Rx-Tx time difference measurement to a-third apparatus, wherein the first Rx-Tx time difference measurement includes an RS reception timestamp and an RS transmission timestamp.

In some implementations, the RS reception timestamp may indicate a first (configured) time when the first RS is received, and the RS transmission timestamp may indicate a second (configured) time when a second RS is transmitted from apparatus 610 to apparatus 620.

In some implementations, the second (configured) time may be prior to or after the first (configured) time.

In some implementations, each of the first (configured) time and the second (configured) time may include at least one of the following: (i) an SFN; (ii) a DFN; (iii) a slot number; and an RS resource ID or an RS resource set ID or pool ID.

In some implementations, processor 612 may also report, via transceiver 616, an amount of a Tx timing change of apparatus 610 to the third apparatus.

In some implementations, the amount of the Tx timing change may indicate a time difference between a first Tx timing of a subframe where a second RS is transmitted from apparatus 610 to apparatus 620, and second Tx timing of a subframe that is closest in time to a subframe where the first RS is received.

In some implementations, processor 612 may also report, via transceiver 616, a timestamp corresponding to the Tx timing change to the third apparatus.

In some implementations, processor 612 may also report, via transceiver 616, a second Rx-Tx time difference measurement performed using a first Tx timing applied before the Tx timing change (e.g., the Rx-Tx time difference measurement reported by UE B with (Rx, Tx) timing at (t3, t2) in FIG. 4), in an event that the first Rx-Tx time difference measurement is performed using a second Tx timing applied after the Tx timing change (e.g., the Rx-Tx time difference measurement reported by UE B with (Rx, Tx) timing at (t3, t3) in FIG. 4). Alternatively, processor 612 may report, via transceiver 616, a second Rx-Tx time difference measurement performed using a first Tx timing applied after the Tx timing change (e.g., the Rx-Tx time difference measurement reported by UE B with (Rx, Tx) timing at (t3, t4) in FIG. 5), in an event that the first Rx-Tx time difference measurement is performed using a second Tx timing applied before the Tx timing change (e.g., the Rx-Tx time difference measurement reported by UE B with (Rx, Tx) timing at (t3, t3) in FIG. 5).

In some implementations, each of the first RS and the second RS may include an SL-PRS, in an event that apparatus 610 is a first UE and apparatus 620 is a second UE.

In some implementations, the first RS may include a DL PRS or a CSI-RS and the second RS may include an SRS, in an event that apparatus 610 is a UE and apparatus 620 is a network node of a wireless network.

In some implementations, the third apparatus may include a location server (e.g., an LMF) or a server UE.

### Illustrative Processes

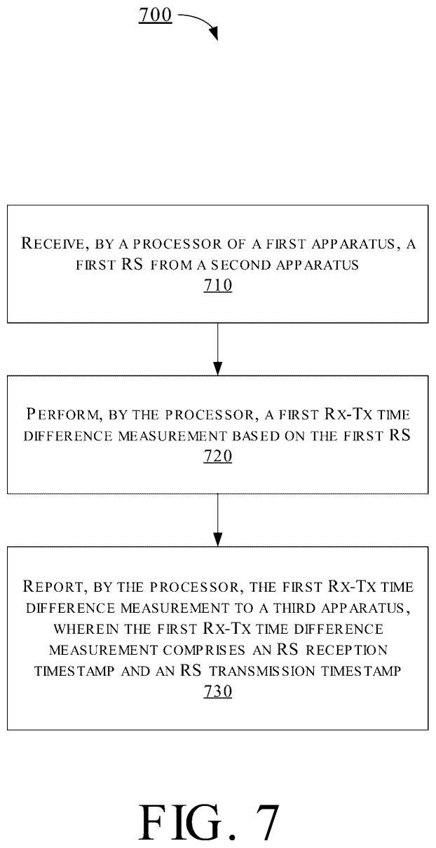

FIG. 7 illustrates an example process 700 in accordance with an implementation of the present disclosure. Process 700 may be an example implementation of above scenarios/schemes, whether partially or completely, with respect to enhancements on reporting of Rx-Tx time difference measurement in mobile communications. Process 700 may represent an aspect of implementation of features of apparatus 610. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by apparatus 610 or any suitable UE or machine type devices. Solely for illustrative purposes and without limitation, process 700 is described below in the context of apparatus 610 as a UE and apparatus 620 as a UE or a BS. Process 700 may begin at block 710.

At 710, process 700 may involve processor 612 of apparatus 610 receiving, via transceiver 616, a first RS from apparatus 620. Process 700 may proceed from 710 to 720.

At 720, process 700 may involve processor 612 performing, via transceiver 616, a first Rx-Tx time difference measurement based on the first RS. Process 700 may proceed from 720 to 730.

At 730, process 700 may involve processor 612 reporting, via transceiver 616, the first Rx-Tx time difference measurement to a third apparatus, wherein the first Rx-Tx time difference measurement includes an RS reception timestamp and an RS transmission timestamp.

In some implementations, the RS reception timestamp may indicate a first (configured) time when the first RS is received, and the RS transmission timestamp may indicate a second (configured) time when a second RS is transmitted from apparatus 610 to apparatus 620.

In some implementations, the second (configured) time may be prior to or after the first (configured) time.

In some implementations, each of the first (configured) time and the second (configured) time may include at least one of the following: (i) an SFN; (ii) a DFN; (iii) a slot number; and an RS resource ID or an RS resource set ID or pool ID.

In some implementations, process 600 may further involve processor 612 reporting, via transceiver 616, an amount of a Tx timing change of apparatus 610 to the third apparatus.

In some implementations, the amount of the Tx timing change may indicate a time difference between a first Tx timing of a subframe where a second RS is transmitted from apparatus 610 to apparatus 620, and a second Tx timing of a subframe that is closest in time to a subframe where the first RS is received.

In some implementations, process 600 may further involve processor 612 reporting, via transceiver 616, a timestamp corresponding to the Tx timing change to the third apparatus.

In some implementations, process 600 may further involve processor 612 reporting, via transceiver 616, a second Rx-Tx time difference measurement performed using a first Tx timing applied before the Tx timing change (e.g., the Rx-Tx time difference measurement reported by UE B with (Rx, Tx) timing at (t3, t2) in FIG. 4), in an event that the first Rx-Tx time difference measurement is performed using a second Tx timing applied after the Tx timing change (e.g., the Rx-Tx time difference measurement reported by UE B with (Rx, Tx) timing at (t3, t3) in FIG. 4). Alternatively, process 600 may further involve processor 612 reporting, via transceiver 616, a second Rx-Tx time difference measurement performed using a first Tx timing applied after the Tx timing change (e.g., the Rx-Tx time difference measurement reported by UE B with (Rx, Tx) timing at (t3, t4) in FIG. 5), in an event that the first Rx-Tx time difference measurement is performed using a second Tx timing applied before the Tx timing change (e.g., the Rx-Tx time difference measurement reported by UE B with (Rx, Tx) timing at (t3, t3) in FIG. 5).

In some implementations, each of the first RS and the second RS may include an SL-PRS, in an event that apparatus 610 is a first UE and apparatus 620 is a second UE.

In some implementations, the first RS may include a DL PRS or a CSI-RS and the second RS may include an SRS, in an event that apparatus 610 is a UE and apparatus 620 is a network node of a wireless network.

In some implementations, the third apparatus may include a location server (e.g., an LMF) or a server UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a first apparatus, a first reference signal (RS) from a second apparatus;
performing, by the processor, a first reception-transmission (Rx-Tx) time difference measurement based on the first RS; and
reporting, by the processor, the first Rx-Tx time difference measurement to a third apparatus, wherein the first Rx-Tx time difference measurement comprises an RS reception timestamp and an RS transmission timestamp.

2. The method of claim 1, wherein the RS reception timestamp indicates a first time when the first RS is received, and the RS transmission timestamp indicates a second time when a second RS is transmitted from the first apparatus to the second apparatus.

3. The method of claim 2, wherein the second time is prior to or after the first time.

4. The method of claim 2, wherein each of the first time and the second time comprises at least one of the following:
a system frame number (SFN);
a direct frame number (DFN);
a slot number; and
an RS resource identifier (ID) or an RS resource set ID or pool ID.

5. The method of claim 1, further comprising:
reporting, by the processor, an amount of a Tx timing change of the first apparatus to the third apparatus.

6. The method of claim 5, wherein the amount of the Tx timing change of the first apparatus indicates a time difference between a first Tx timing of a subframe where a second RS is transmitted from the first apparatus to the second apparatus, and a second Tx timing of the first apparatus of a subframe that is closest in time to a subframe where the first RS is received.

7. The method of claim 5, further comprising:
reporting, by the processor, a timestamp corresponding to the Tx timing change to the third apparatus.

8. The method of claim 5, further comprising:
reporting, by the processor, a second Rx-Tx time difference measurement performed using a first Tx timing applied before the Tx timing change, in an event that the first Rx-Tx time difference measurement is performed using a second Tx timing applied after the Tx timing change; or
reporting, by the processor, a second Rx-Tx time difference measurement performed using a first Tx timing applied after the Tx timing change, in an event that the first Rx-Tx time difference measurement is performed using a second Tx timing applied before the Tx timing change.

9. The method of claim 2, wherein each of the first RS and the second RS comprises a sidelink-positioning reference signal (SL-PRS), in an event that the first apparatus is a first user equipment (UE) and the second apparatus is a second UE; or the first RS comprises a DL positioning reference signal (PRS) or a channel state information-reference signal (CSI-RS) and the second RS comprises a sounding reference signal (SRS), in an event that the first apparatus is a UE and the second apparatus is a network node of a wireless network.

10. The method of claim 1, wherein the third apparatus comprises a location server or a server user equipment (UE).

11. A first apparatus, comprising:
a transceiver which, during operation, wirelessly communicates with a second apparatus or a third apparatus; and
a processor communicatively coupled to the transceiver such that, during operation, the processor performs operations comprising:
receiving, via the transceiver, a first reference signal (RS) from the second apparatus;
performing, via the transceiver, a first reception-transmission (Rx-Tx) time difference measurement based on the first RS; and
reporting, via the transceiver, the first Rx-Tx time difference measurement to the third apparatus, wherein the first Rx-Tx time difference measurement comprises an RS reception timestamp and an RS transmission timestamp.

12. The first apparatus of claim 11, wherein the RS reception timestamp indicates a first time when the first RS is received, and the RS transmission timestamp indicates a second time when a second RS is transmitted from the first apparatus to the second apparatus.

13. The first apparatus of claim 12, wherein the second time is prior to or after the first time.

14. The first apparatus of claim 12, wherein each of the first time and the second time comprises at least one of the following:
a system frame number (SFN);
a direct frame number (DFN);
a slot number; and
an RS resource identifier (ID) or an RS resource set ID or pool ID.

15. The first apparatus of claim 11, wherein, during operation, the processor further performs operations comprising:
reporting, via the transceiver, an amount of a Tx timing change of the first apparatus to the third apparatus.

16. The first apparatus of claim 15, wherein the amount of the Tx timing change of the first apparatus indicates a time difference between a first Tx timing of a subframe where a second RS is transmitted from the first apparatus to the second apparatus, and a second Tx timing of the first apparatus of a subframe that is closest in time to a subframe where the first RS is received.

17. The first apparatus of claim 15, wherein, during operation, the processor further performs operations comprising:
reporting, via the transceiver, a timestamp corresponding to the Tx timing change to the third apparatus.

18. The first apparatus of claim 15, wherein, during operation, the processor further performs operations comprising:
reporting, by the processor, a second Rx-Tx time difference measurement performed using a first Tx timing applied before the Tx timing change, in an event that the first Rx-Tx time difference measurement is performed using a second Tx timing applied after the Tx timing change; or
reporting, by the processor, a second Rx-Tx time difference measurement performed using a first Tx timing applied after the Tx timing change, in an event that the first Rx-Tx time difference measurement is performed using a second Tx timing applied before the Tx timing change.

19. The first apparatus of claim 12, wherein each of the first RS and the second RS comprises a sidelink-positioning reference signal (SL-PRS), in an event that the first apparatus is a first user equipment (UE) and the second apparatus is a second UE; or the first RS comprises a DL positioning reference signal (PRS) or a channel state information-reference signal (CSI-RS) and the second RS comprises a sounding reference signal (SRS), in an event that the first apparatus is a UE and the second apparatus is a network node of a wireless network.

20. The first apparatus of claim 11, wherein the third apparatus comprises a location server or a server user equipment (UE).
